(19) United States
(12) Patent Application Publication
(10) Pub. No.: US 2026/0023710 A1
(43) Pub. Date: Jan. 22, 2026

(54) ADDRESS ASSIGNMENT METHOD, ELECTRONIC DEVICE, MULTI-DEVICE SYSTEM, AND STORAGE MEDIUM

(71) Applicant: ECOFLOW INC., Shenzhen (CN)

(72) Inventors: Yaxiong WANG, Shenzhen (CN); Dong WU, Shenzhen (CN); Xi CHEN, Shenzhen (CN); Lei WANG, Shenzhen (CN)

(21) Appl. No.: 19/341,912

(22) Filed: Sep. 26, 2025

Related U.S. Application Data
(63) Continuation of application No. PCT/CN2024/083146, filed on Mar. 22, 2024.

(30) Foreign Application Priority Data
Mar. 29, 2023 (CN) 202310363084.4

(51) Int. Cl. G06F 13/42

(52) U.S. Cl. CPC G06F 13/4204

(57) ABSTRACT

This application provides an address assignment method. According to the method, when an address assignment request is received through a first parallel port, an address assignment function of a parallel port other than the first parallel port is disabled; an address assignment instruction is sent to the first parallel port; and when an address configuration complete instruction is received through the first parallel port, the address assignment function of the parallel port other than the first parallel port is enabled.

### CROSS-REFERENCE TO RELATED APPLICATIONS

This application is a continuation application of PCT patent application No. PCT/CN2024/083146, filed on Mar. 22, 2024, which claims priority to Chinese Patent Application No. 202310363084.4, filed on Mar. 29, 2023, all of which is incorporated herein by reference in their entirety.

### TECHNICAL FIELD

This application relates to the field of new energy technologies, and specifically, to an address assignment method, an electronic device, a multi-device system, and a storage medium.

### BACKGROUND

The description herein provides only background information related to this application, but does not necessarily constitute the exemplary technology.

In a master-slave architecture, for example, in a multi-device system of energy storage devices (such as a battery pack), a master device implements communication with a plurality of slave devices through a same communication bus. When detecting that a slave device accesses, the master device of the multi-device system assigns an address to the accessed slave device. However, when a plurality of slave devices simultaneously access the master device, the master device cannot accurately assign addresses to the plurality of accessed slave devices.

### SUMMARY

According to embodiments of this application, an address assignment method, an electronic device, a multi-device system, and a storage medium are provided.

An embodiment of this application provides an address assignment method, applied to a master device of a multi-device system. The master device is connected to a slave device through a parallel port; and the slave device is connected to the master device or another slave device through a parallel port. The method includes: disabling, when receiving an address assignment request through a first parallel port, an address assignment function of a parallel port other than the first parallel port, where the first parallel port is any parallel port of the master device; sending an address assignment instruction to the first parallel port, where the address assignment instruction is configured for assigning an address to a slave device sending the address assignment request; and enabling, when receiving an address configuration complete instruction through the first parallel port, the address assignment function of the parallel port other than the first parallel port.

An embodiment of this application further provides an address assignment apparatus, running in a master device of a multi-device system. The master device is connected to a slave device through a parallel port; and the slave device is connected to the master device or another slave device through a parallel port. The apparatus includes: a disabling unit, configured to disable, when receiving an address assignment request through a first parallel port, an address assignment function of a parallel port other than the first parallel port, where the first parallel port is any parallel port of the master device; a sending unit, configured to send an address assignment instruction to the first parallel port, where the address assignment instruction is configured for assigning an address to a slave device sending the address assignment request; and a control unit, configured to enable, when receiving an address configuration complete instruction through the first parallel port, the address assignment function of the parallel port other than the first parallel port.

An embodiment of this application further provides an electronic device used as a master device. The electronic device includes: a parallel port, configured to connect to a slave device; a memory, having computer-readable instructions stored therein; and a processor, configured to execute the computer-readable instructions stored in the memory, to implement the address assignment method.

An embodiment of this application further provides a multi-device system, where the multi-device system includes a plurality of electronic devices; and a master device and a slave device are configured in the plurality of electronic devices. The master device is connected to the slave device through a parallel port; and the slave device is connected to the master device or another slave device through a parallel port, where the master device executes the address assignment method.

An embodiment of this application further provides a computer-readable storage medium. The computer-readable storage medium has computer-readable instructions stored therein, and the computer-readable instructions are executed by a processor in an electronic device to implement the address assignment method.

Details of one or more embodiments of this application are provided in the accompany drawings and descriptions below. Other features, objectives, and advantages of this application are apparent from the descriptions, drawings, and claims.

### BRIEF DESCRIPTION OF THE DRAWINGS

To describe the technical solutions in the embodiments of this application or the exemplary technology more clearly, the following briefly introduces the accompanying drawings required for describing the embodiments or the exemplary technology. Apparently, the accompanying drawings in the following descriptions show merely some embodiments of this application, and a person of ordinary skill in the art may still derive accompanying drawings of other embodiments from the accompanying drawings without creative efforts.

FIG. 1 is a diagram of an application scenario of an address assignment method according to an embodiment of this application;

FIG. 2 is a flowchart of an address assignment method according to an embodiment of this application;

FIG. 3 is a schematic diagram of a parallel port in a master device according to an embodiment of this application;

FIG. 4 is a schematic diagram of an address number of a slave device according to an embodiment of this application;

FIG. 5 is a flowchart of an address assignment method according to another embodiment of this application;

FIG. 6 is a flowchart of an address assignment method according to another embodiment of this application;

FIG. 7 is a diagram of function modules of an address assignment apparatus according to an embodiment of this application; and

FIG. 8 is a schematic structural diagram of an electronic device for implementing an address assignment method according to an embodiment of this application.

### DETAILED DESCRIPTION

To make the objectives, technical solutions, and advantages of this application clearer, the following describes this application in detail with reference to the accompanying drawings and the specific embodiments.

It needs to be noted that, in this application, “at least one” means one or more, and “a plurality of” means two or more. The term “and/or” describes an association relationship between associated objects and represents that three relationships may exist. For example, A and/or B may represent that: only A exists, both A and B exist, and only B exists, where A and B may be singular or plural. The terms such as “first”, “second”, “third”, and “fourth” (if any) in the specification, the claims, and the accompanying drawings of this application are used for distinguishing between similar objects, and are not used for describing any particular order or sequence.

In the embodiments of this application, the term “exemplary” or “for example” is used to represent giving an example, an illustration, or a description. Any embodiment or design scheme described as “exemplary” or “for example” in the embodiments of this application should not be explained as being more preferred or having more advantages than another embodiment or design scheme. To be precise, the use of the term such as “exemplary” or “for example” is intended to present a related concept in a specific manner. The following embodiments and features in the embodiments may be mutually combined in case that no conflict occurs.

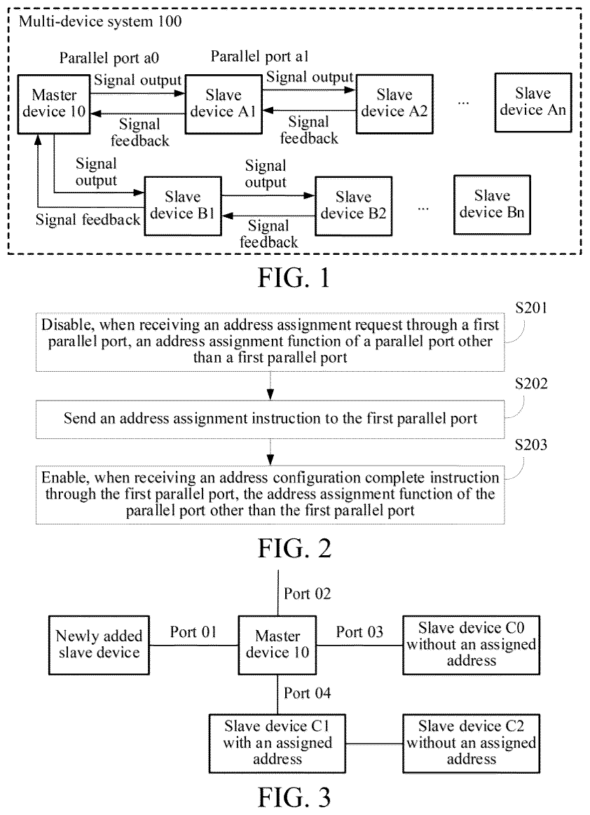

In a master-slave architecture, for example, in a multi-device system of energy storage devices (such as a battery pack), a master device implements communication with a plurality of slave devices through a same communication bus. When detecting that a slave device accesses, the master device of the multi-device system assigns an address to the accessed slave device. However, when a plurality of slave devices simultaneously access the master device, an address assignment instruction sent by the master device is received by all slave devices connected on the communication bus. In this case, a slave device for which the address assignment instruction specifically assigns an address cannot be determined. Consequently, the master device cannot accurately assign addresses to the plurality of accessed slave devices. The following describes an application scenario of an address assignment method according to an embodiment of this application with reference to FIG. 1.

A multi-device system 100 shown in FIG. 1 includes a master device 10 and at least one slave device (for example, a slave device A1, a slave device A2, . . . , a slave device An, a slave device B1, a slave device B2, . . . , and a slave device Bn in FIG. 1). The master device 10 is configured with a plurality of parallel ports, and the master device 10 is connected to the at least one slave device through a parallel port. A slave device may be connected to the master device 10 or another slave device through the parallel port. The slave devices are connected to the master device 10 in a cascaded manner. When detecting that a slave device in the multi-device system 100 accesses, the master device 10 assigns an address to the accessed slave device.

As shown in FIG. 1, the master device 10 in the multi-device system 100 is connected to two slave device links. Because control logic of the two slave device links is the same, for ease of description, one slave device link is used for description in this embodiment of this application. Specifically, the master device 10 starts a parallel port a0, and when the slave device A1 detects that the master device 10 outputs a signal through the parallel port a0, the slave device A1 feeds back a signal to the master device 10. In this case, the master device 10 determines that the slave device A1 is connected to the parallel port a0, and further, the master device 10 assigns an address to the slave device A1. After address assignment for the slave device A1 is completed, the slave device A1 outputs the signal through a parallel port al of the slave device A1. When the slave device A2 detects an output signal sent by the slave device A1 through the parallel port al, the slave device A2 may feed back a signal to the slave device A1. When the slave device A1 detects the feedback signal, the slave device A1 notifies the master device 10 that the slave device A2 accesses the multi-device system 100, and then the master device 10 assigns an address to the slave device A2.

When the master device 10 detects feedback signals of the slave device A1 and the slave device B1 at the same time, the address assigned by the master device 10 is received by the slave device A1 and the slave device B1 at the same time. Similarly, if addresses are assigned to the slave device A1, the slave device A2, the slave device B1, and the slave device B2, when a slave device A3 and a slave device B3 simultaneously access the multi-device system 100, the slave device A2 and the slave device B2 simultaneously feed back information about the accessing slave devices to the master device 10. In this case, an address assigned by the master device 10 is also received by the slave device A3 and the slave device B3 at the same time. Consequently, the master device 10 cannot sequentially assign addresses to the slave devices, resulting in low accuracy of address assignment.

Based on the foregoing problem, an embodiment of this application provides an address assignment method, so that a master device can sequentially assign addresses to slave devices, thereby ensuring accuracy of address assignment. The following describes the address assignment method with reference to a flowchart shown in FIG. 2.

Both the master device and the slave device in this embodiment of this application may be energy storage devices. The energy storage device may be a battery pack having only a power storage or discharging function, or may be a mobile energy storage device having a power conversion function. For example, the energy storage device may also be applied to self-moving devices such as an automobile device, a grass mowing device, a floor sweeping device, a mine clearance device, and a cruising device. This is not limited herein.

FIG. 2 shows a flowchart of an address assignment method according to an embodiment of this application. The address assignment method is applied to a master device (for example, the master device 10 in FIG. 1). The master device may be an electronic device such as an energy storage device. Based on different requirements, a sequence of steps in the flowchart may be changed, or some steps may be omitted.

S201: Disable, when receiving an address assignment request through a first parallel port, an address assignment function of a parallel port other than the first parallel port, where the first parallel port is any parallel port of the master device.

In at least one embodiment of this application, generation of the address assignment request may be triggered when any parallel port of the master device accesses the slave device. Generation of the address assignment request may alternatively be triggered when a slave device for which address assignment is completed accesses another slave device. The parallel port other than the first parallel port may include: a parallel port accessed by a slave device without an assigned address and a parallel port not accessed by any slave device.

In an embodiment, after the master device disables the address assignment function of the parallel port other than the first parallel port, the parallel port (for example, a port 03 in FIG. 3) other than the first parallel port may still access a new slave device, but the port 03 does not send an address assignment instruction to a connected slave device C0, and does not respond to an address assignment request of the slave device C0. In an embodiment, after the address assignment function is disabled, the parallel port may still perform another function, such as a charging and discharging function. The address assignment function of the parallel port other than the first parallel port is disabled, so that an address assigned by the master device to a slave device of the first parallel port can be prevented from being received by another slave device, thereby improving order of address assignment.

In another embodiment, the master device disables the parallel port other than the first parallel port. After the master device disables the parallel port other than the first parallel port, all functions of the parallel port other than the first parallel port are disabled. In this case, even if a new slave device accesses the parallel port, the new accessed slave device has only a physical connection relationship with the parallel port and does not have an electrical connection relationship with the parallel port, that is, communication or power transmission does not exist between the two. Therefore, the slave device accessing the parallel port cannot receive the address assigned by the master device to the first parallel port either. In an embodiment, disabling a parallel port may alternatively be disabling only an address assignment function of the parallel port, to be specific, only prohibiting the parallel port from sending an address assignment instruction to a connected slave device or skipping responding to an address assignment request sent by an accessed slave device. The parallel port other than the first parallel port is disabled, so that it can be avoided that the master device receives an address assignment request of the parallel port other than the first parallel port when assigning an address to the slave device of the first parallel port, to avoid that addresses cannot be assigned orderly due to simultaneous access of a plurality of slave devices, thereby improving the address assignment accuracy.

In another embodiment, the master device disables a parallel port other than the first parallel port not accessed by any slave device, and sends a disable instruction to a parallel port other than the first parallel port that a slave device accesses. The disable instruction is configured for instructing a device accessed by a slave device without an assigned address to disable a corresponding parallel port. The device accessed by a slave device without an assigned address may be the master device or may be a slave device. In other words, when the address assignment function of the parallel port other than the first parallel port is disabled, it may be determined based on a status of accessed slave devices. Specifically, when a parallel port of the master device or the slave device is not accessed by any slave device, the parallel port may be directly disabled. When a slave device without an assigned address accesses the master device or the slave device, a corresponding parallel port is also disabled.

The parallel port in the master device provided in this embodiment of this application is described with reference to FIG. 3. As shown in FIG. 3, parallel ports of the master device 10 include a port 01, a port 02, a port 03, and a port 04. The port 02 is not connected to any slave device. A slave device C0 without an assigned address is connected to the port 03. A slave device C1 with an assigned address is connected to the port 04, and a slave device C2 without an assigned address is connected to the slave device C1. Assuming that the first parallel port is the port 01, when receiving an address assignment request through the port 01, the master device 10 sends a disable instruction to the port 02, the port 03, and the port 04, and sends the disable instruction through the port 03 and the port 04 to the corresponding slave devices C0 and C1. The disable instruction is configured for instructing the master device 10 to disable the port 02 and the port 03 and instructing the slave device C1 to disable a parallel port through which the slave device C1 is connected to the slave device C2, thereby disabling address assignment functions of parallel ports other than the port 01.

Because another parallel port not accessed by any slave device and another parallel port accessed by a slave device without an assigned address are disabled, slave devices on corresponding parallel ports cannot detect a signal outputted by the master device or a slave device at a previous level. Therefore, the address assigned by the master device to the slave device of the first parallel port (for example, the port 01) can be prevented from being received by another slave device without an assigned address, so that the master device can orderly assign addresses to slave devices.

In at least one embodiment of this application, if a slave device without an assigned address accesses the slave device C1, when receiving a reply signal of the slave device C1 to the disable instruction, the master device determines that the slave device C1 completes disabling a corresponding parallel port.

S202: Send an address assignment instruction to the first parallel port, where the address assignment instruction is configured for assigning an address to a slave device sending the address assignment request.

In at least one embodiment of this application, the slave device sending the address assignment request may be a slave device (for example, a newly added slave device in FIG. 3) directly connected to the master device, or may be a slave device, for example, the slave device C2 in FIG. 3, connected to a slave device with an assigned address.

In at least one embodiment of this application, the master device determines a port address of the first parallel port, and determines a hierarchical relationship of the slave device sending the address assignment request in the multi-device system, and further assigns, based on the port address and the hierarchical relationship, the address to the slave device sending the address assignment request.

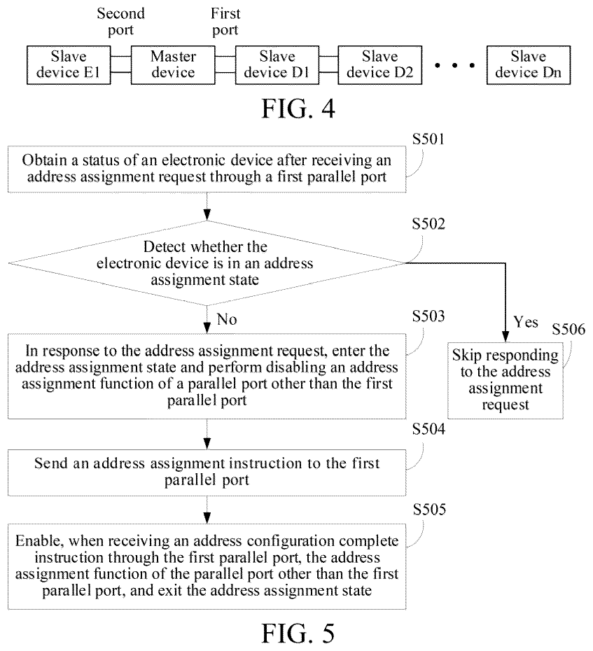

An address number of a slave device provided in this embodiment of this application is described with reference to FIG. 4. As shown in FIG. 4, it is assumed that the master device includes a first port and a second port. A slave device D1, a slave device D2, . . . , and a slave device Dn are sequentially connected to the first port. A slave device E1 is connected to the second port. If a port address of the first port is 10x, because a level of the slave device D1 in the multi-device system is 1, an address number assigned by the master device to the slave device D1 may be 101. Because a level of the slave device D2 in the multi-device system is 2, an address number assigned by the master device to the slave device D2 may be 102, and so on. Correspondingly, a port address of the second port may be 20x. Because a level of the slave device E1 in the multi-device system is 1, an address number assigned by the master device to the slave device E1 may be 201.

Assigning addresses to the slave devices with reference to the port address and the hierarchical relationship can improve properness of address assignment. In this embodiment of this application, different address combinations are configured for different parallel ports of a master device, to distinguish between and manage statuses of slave devices of the different parallel ports, thereby facilitating improving efficiency of controlling the slave devices.

S203: Enable, when receiving an address configuration complete instruction through the first parallel port, the address assignment function of the parallel port other than the first parallel port.

In at least one embodiment of this application, after the master device enables the address assignment function of the parallel port other than the first parallel port, all parallel ports restore a normal function, and can receive an address assignment request of a newly accessed slave device and transmit an address assignment instruction generated by the master device to a corresponding slave device.

By using the foregoing address assignment method, when the first parallel port receives the address assignment request, the address assignment function of the parallel port other than the first parallel port is disabled, so that the address assigned by the master device to the slave device sending the address assignment request can be prevented from being received by another slave device, thereby improving order of address assignment, and improving accuracy of address assignment.

FIG. 5 shows a flowchart of an address assignment method according to another embodiment of this application. The address assignment method is applied to a master device (for example, the master device 10 in FIG. 1). The master device may be an electronic device such as an energy storage device. As shown in FIG. 5, the address assignment method may include the following steps S501 to S505. Based on different requirements, a sequence of steps in the flowchart may be changed, or some steps may be omitted.

S501: Obtain a status of the master device after receiving an address assignment request through a first parallel port.

In at least one embodiment of this application, the status of the master device includes an address assignment state and a non-address assignment state. The status may be read by using a corresponding status identifier. For example, when the status identifier is a first preset value, it indicates that the master device is in the address assignment state, and when the status identifier is a second preset value, it indicates that the master device is not in the address assignment state, that is, in the non-address assignment state. It may be understood that, a corresponding status may alternatively be determined based on all current execution statuses of the master device. For example, when an address assignment function is disabled or address assignment is performed, it is determined that the master device is in the address assignment state; otherwise, it is determined that the master device is in the non-address assignment state.

S502: Detect whether the master device is in the address assignment state.

In at least one embodiment of this application, whether the master device assigns an address to a slave device may be detected by using a specific value of the foregoing status identifier. If it is detected that the status identifier is the first preset value, it is determined that the master device is in the address assignment state, and step S506 is performed. If it is confirmed that the master device is in the non-address assignment state, step S503 is performed.

S503: When the master device is not in an address assignment state, in response to the address assignment request, enter the address assignment state and perform the step of disabling an address assignment function of a parallel port other than the first parallel port.

After the master device enters the address assignment state, a value corresponding to the status is updated to the first preset value, to indicate that the master device is currently in the address assignment state. The address assignment status may include two stages: a disable stage, and an execution stage. The disable stage means disabling an address assignment function of a parallel port other than the first parallel port. When there is no parallel port other than the first parallel port, the master device does not need to enter the disable stage. The execution stage corresponds to a stage of S504.

S504: Send an address assignment instruction to the first parallel port, where the address assignment instruction is configured for assigning an address to a slave device sending the address assignment request.

S505: Enable, when receiving an address configuration complete instruction through the first parallel port, the address assignment function of the parallel port other than the first parallel port, and exit the address assignment state.

When the master device exits the address assignment state, the status identifier is updated to the second preset value, to indicate that the master device is not currently in the address assignment state.

For detailed content of steps S503 to S505, refer to the detailed descriptions of steps S201 to S203 in FIG. 2 in the foregoing specification. Details are not described herein again.

In this embodiment, before the address assignment request is responded to, the status of the master device is first detected, and the address assignment request is responded to only when it is determined that the master device is not in the address assignment state. In addition, in this embodiment of this application, when address assignment is performed in response to the address assignment request, the master device enters the address assignment state. In this case, the master device does not send an address to a parallel port other than the first parallel port, so that the address generated by the master device can be effectively prevented from being received by a plurality of slave devices.

S506: Skip responding to the address assignment request when the master device is in the address assignment state.

In at least one embodiment of this application, when the master device is in the address assignment state, even if a new slave device accesses the master device, the master device does not respond to an address assignment request sent by the slave device, but responds to the address assignment request until previous address assignment is completed and the master device exits the address assignment state.

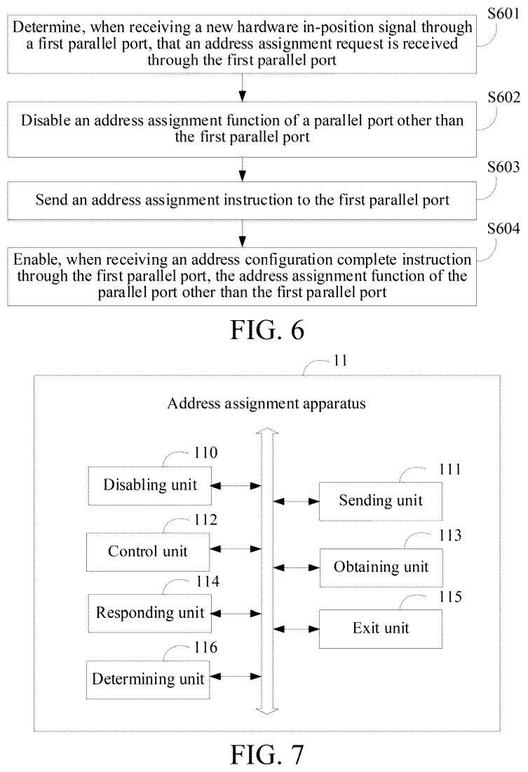

FIG. 6 shows a flowchart of an address assignment method according to another embodiment of this application. The address assignment method is applied to a master device (for example, the master device 10 in FIG. 1). The master device may be an electronic device such as an energy storage device. As shown in FIG. 6, the address assignment method may include the following steps S601 to S604. Based on different requirements, a sequence of steps in the flowchart may be changed, or some steps may be omitted.

S601: Determine, when receiving a new hardware in-position signal through the first parallel port, that the address assignment request is received through the first parallel port.

Reception of a hardware in-position signal is described with reference to FIG. 3. As shown in FIG. 3, the slave device C1 is connected to the slave device C2, the slave device C1 outputs a signal to the slave device C2, and the slave device C2 outputs a feedback signal after receiving the signal. When the slave device C1 receives the feedback signal, and a value of the feedback signal is a valid value (for example, a preset high level or low level), the slave device C1 confirms that an in-position signal of the slave device C2 is received and sends the in-position signal to the master device 10. The master device 10 receives the hardware in-position signal through the port 04. When the slave device C0 is newly accessed through the port 03, it is determined that the port 03 receives a new hardware in-position signal.

S602: Disable an address assignment function of a parallel port other than the first parallel port, where the first parallel port is any parallel port of the master device.

S603: Send an address assignment instruction to the first parallel port, where the address assignment instruction is configured for assigning an address to a slave device sending the address assignment request.

S604: Enable, when receiving an address configuration complete instruction through the first parallel port, the address assignment function of the parallel port other than the first parallel port.

For detailed content of steps S602 to S604, refer to the detailed descriptions of steps S201 to S203 in FIG. 2 in the foregoing specification. Details are not described herein again.

In this embodiment of this application, when the new hardware in-position signal is received, it is determined that an address assignment request is received, so that the master device is triggered to assign an address to a slave device that feeds back the hardware in-position signal, thereby improving timeliness of address assignment.

FIG. 7 shows a diagram of function modules of an address assignment apparatus according to an embodiment of this application. An address assignment apparatus 11 runs in a master device of a multi-device system. The master device is connected to a slave device through a parallel port. The slave device is connected to the master device or another slave device through the parallel port. The address assignment apparatus 11 includes a disabling unit 110, a sending unit 111, a control unit 112, an obtaining unit 113, a responding unit 114, an exit unit 115, and a determining unit 116. The module/unit referred to in this application refers to a series of computer-readable instruction segments that can be obtained by the processor 13 and that can implement a fixed function, and are stored in the memory.

The disabling unit 110 is configured to disable, when receiving an address assignment request through a first parallel port, an address assignment function of a parallel port other than the first parallel port. The first parallel port is any parallel port of the master device. The sending unit 111 is configured to send an address assignment instruction to the first parallel port. The address assignment instruction is configured for assigning an address to a slave device sending the address assignment request. The control unit 112 is configured to enable, when receiving an address configuration complete instruction through the first parallel port, the address assignment function of the parallel port other than the first parallel port.

Further, the obtaining unit 113 is configured to obtain a status of the master device. The responding unit 114 is configured to: when the master device is not in an address assignment state, in response to the address assignment request, enter the address assignment state and perform the step of disabling an address assignment function of a parallel port other than the first parallel port. The responding unit 114 is further configured to skip responding to the address assignment request when the master device is in the address assignment state.

Further, the exit unit 115 is configured to exit the address assignment state when receiving the address configuration complete instruction through the first parallel port.

Further, the determining unit 116 is configured to determine, when receiving a new hardware in-position signal through the first parallel port, that the address assignment request is received through the first parallel port.

For detailed content of functions of the modules/units, refer to the detailed descriptions of FIG. 2 in the foregoing specification. Details are not described herein again.

It can be learned from the foregoing technical solution that, in this embodiment of this application, when the first parallel port receives the address assignment request, the address assignment function of the parallel port other than the first parallel port is disabled, so that the address assigned by the master device to the slave device sending the address assignment request can be prevented from being received by another slave device, thereby improving order of address assignment, and improving accuracy of address assignment.

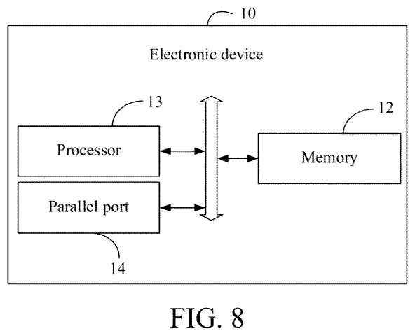

FIG. 8 shows a schematic structural diagram of an electronic device for implementing an address assignment method according to an embodiment of this application.

In an embodiment of this application, the electronic device 10 includes, but is not limited to, a parallel port 14, a memory 12, a processor 13, and computer-readable instructions, such as an address assignment program, stored in the memory 12 and executable on the processor 13. The parallel port 14 is configured to connect to a slave device.

A person skilled in the art may understand that, the schematic diagram is merely an example of the electronic device 10, and does not constitute a limitation to the electronic device 10, and the electronic device may include more or fewer components than those illustrated, or a combination of some components, or have different components. For example, the electronic device 10 may further include an input/output device, a network access device, a bus, and the like.

The processor 13 may be a central processing unit (Central Processing Unit, CPU), or may be another general-purpose processor, a digital signal processor (Digital Signal Processor, DSP), an application specific integrated circuit (Application Specific Integrated Circuit, ASIC), a field-programmable gate array (Field-Programmable Gate Array, FPGA), another programmable logic device, a discrete gate or a transistor logic device, a discrete hardware component, or the like. The general-purpose processor may be a microprocessor or the processor may be any conventional processor or the like. The processor 13 is an operation core and a control center of the electronic device 10, is connected to various parts of the entire electronic device 10 through various interfaces and lines, and executes an operating system of the electronic device 10 and various installed application programs and program code.

For example, the computer-readable instructions may be divided into one or more modules/units, and the one or more modules/units are stored in the memory 12 and executed by the processor 13 to complete this application. The one or more modules/units may be a series of computer-readable instruction segments that can complete specific functions, and the computer-readable instruction segments are configured to describe an execution process of the computer-readable instructions in the electronic device 10. For example, the computer-readable instructions may be divided into a disabling unit 110, a sending unit 111, a control unit 112, an obtaining unit 113, a responding unit 114, an exit unit 115, and a determining unit 116.

The memory 12 may be configured to store computer-readable instructions and/or modules. By running or executing the computer-readable instructions and/or modules stored in the memory 12, and invoking data stored in the memory 12, the processor 13 implements various functions of the electronic device 10. The memory 12 may mainly include a program storage region and a data storage region. The program storage region may store an operating system, an application program required by at least one function (for example, a sound playing function and an image playing function), and the like. The data storage area may store data or the like created according to the use of the electronic device. The memory 12 may include non-volatile and volatile memories, for example, a hard disk, an internal memory, a plug-in hard disk, a smart media card (Smart Media Card, SMC), a secure digital (Secure Digital, SD) card, a flash card (Flash Card), at least one magnetic disk storage device, a flash storage device, or another storage device.

The memory 12 may be an external memory and/or an internal memory of the electronic device 10. Further, the memory 12 may be a memory having a physical form, such as a memory bank or a TF card (Trans-flash Card).

When the modules/units integrated in the electronic device 10 are implemented in the form of software functional units and sold or used as independent products, the integrated modules/units may be stored in a computer-readable storage medium. Based on such understanding, all or some of the procedures of the methods in the embodiments may be implemented in this application by computer-readable instructions instructing relevant hardware. The computer-readable instructions may be stored in a computer-readable storage medium. During execution of the computer-readable instructions by the processor, steps of the foregoing method embodiments may be implemented.

The computer-readable instructions include computer-readable instruction code. The computer-readable instruction code may be in a form of source code, object code, an executable file, some intermediate forms, or the like. The computer-readable medium may include: any entity or apparatus that is capable of carrying the computer-readable instruction code, a recording medium, a USB flash drive, a removable hard disk, a magnetic disk, an optical disc, a computer memory, a read-only memory (ROM, Read-Only Memory), and a random access memory (RAM, Random Access Memory).

With reference to FIG. 2 to FIG. 6, the memory 12 in the electronic device 10 stores the computer-readable instructions, and the processor 13 may execute the computer-readable instructions stored in the memory 12 to implement the address assignment method shown in FIG. 2.

Specifically, for a specific implementation of the foregoing computer-readable instructions by the processor 13, refer to descriptions of related steps in the corresponding embodiments of FIG. 2 to FIG. 6. Details are not described herein again.

In the several embodiments provided in this application, it should be understood that the disclosed system, apparatus, and method may be implemented in other manners. For example, the described apparatus embodiment is merely an example. For example, the module division is merely logical function division and may be other division during actual implementation.

The modules described as separate parts may or may not be physically separate, and parts displayed as modules may or may not be physical units, may be located in one position, or may be distributed on a plurality of network units. Some or all of the modules may be selected according to actual needs to achieve the objectives of the solutions of the embodiments.

In addition, function modules in the embodiments of this application may be integrated into one processing unit, or each of the units may be physically separated, or two or more units may be integrated into one unit. The integrated unit may be implemented in the form of hardware, or may be implemented in the form of a software function unit.

Therefore, from any point of view, the embodiments should be considered as exemplary and non-restrictive. The scope of this application is limited by the appended claims rather than the foregoing descriptions. Therefore, all changes that fall within the meaning and range of equivalents of the claims are intended to be covered by this application. No related reference numerals in the claims should be considered as limitations to the related claims.

In addition, apparently, the term “include” does not exclude other units or steps, and a singular form does not exclude a plural case. A plurality of units or apparatuses may also be implemented by one unit or apparatus through software or hardware. The terms such as “first” and “second” are only used to denote names, and do not represent any particular order.

Finally, it should be noted that the above embodiments are merely used for describing the technical solutions of this application, but are not intended to limit this application. Although this application is described in detail with reference to preferred embodiments, a person of ordinary skill in the art should understand that modifications or equivalent replacements made to the technical solution of this application do not depart from the spirit and scope of the technical solution of this application.

What is claimed is:

1. An address assignment method, applied to a master device of a multi-device system, wherein the master device is connected to a slave device through a parallel port; the slave device is connected to the master device or another slave device through a parallel port; and the method comprises:
disabling, when receiving an address assignment request through a first parallel port, an address assignment function of a parallel port other than the first parallel port, wherein the first parallel port is any parallel port of the master device;
sending an address assignment instruction to the first parallel port, wherein the address assignment instruction is configured for assigning an address to a slave device sending the address assignment request; and
enabling, when receiving an address configuration complete instruction through the first parallel port, the address assignment function of the parallel port other than the first parallel port.

2. The method according to claim 1, wherein the disabling an address assignment function of a parallel port other than the first parallel port comprises:
disabling the parallel port other than the first parallel port.

3. The method according to claim 1, wherein the disabling an address assignment function of a parallel port other than the first parallel port comprises:
disabling a parallel port other than the first parallel port not accessed by any slave device; and
sending a disable instruction to a parallel port other than the first parallel port that a slave device accesses, wherein the disable instruction is configured for instructing a device accessed by a slave device without an assigned address to disable a corresponding parallel port.

4. The method according to claim 1, wherein after the step of receiving an address assignment request through a first parallel port, the method further comprises:
obtaining a status of the master device; and
when the master device is not in an address assignment state, in response to the address assignment request, entering the address assignment state and performing the step of disabling an address assignment function of a parallel port other than the first parallel port.

5. The method according to claim 4, wherein the method further comprises:
exiting the address assignment state when receiving the address configuration complete instruction through the first parallel port.

6. The method according to claim 1, wherein the method further comprises:
skipping responding to the address assignment request when the master device is in an address assignment state.

7. The method according to claim 1, wherein the method further comprises:
determining, when receiving a new hardware in-position signal through the first parallel port, that the address assignment request is received through the first parallel port.

8. An electronic device, used as a master device, wherein the electronic device comprises:
a parallel port, configured to connect to a slave device;
a memory, having computer-readable instructions stored therein; and
a processor, configured to execute the computer-readable instructions stored in the memory, to implement the address assignment method according to claim 1.

9. A multi-device system, comprising a plurality of electronic devices, wherein a master device and a slave device are configured in the plurality of electronic devices; and
the master device is connected to the slave device through a parallel port; and the slave device is connected to the master device or another slave device through a parallel port, wherein
the master device executes the address assignment method according to claim 1.

10. A computer-readable storage medium, wherein the computer-readable storage medium has computer-readable instructions stored therein, and the computer-readable instructions are executed by a processor in an electronic device to implement the address assignment method according to claim 1.
